(19) United States
(12) Patent Application Publication
(10) Pub. No.: US 2011/0115913 A1
(43) Pub. Date: May 19, 2011

(54) AUTOMATED VEHICLE SURROUNDING AREA MONITOR AND DISPLAY SYSTEM

(76) Inventors: Werner Lang, Ergersheim (DE); Michael Witzke, Ansbach (DE); Johann Fellner, Dietenhofen (DE); Peter Geißendörfer, Ergersheim (DE); Jon Hohenhaus, Neustadt a. d. Aisch (DE)

(21) Appl. No.: 12/946,163

(22) Filed: Nov. 15, 2010

(30) Foreign Application Priority Data
Nov. 17, 2009 (DE) 102009046791.2

(51) Int. Cl. H04N 7/18

(52) U.S. Cl. 348/148

(57) ABSTRACT

At least a first and second monitoring device that outputs display signals to a control device. A display device connected with the control device is able to display the display signals from the monitoring devices in at least two sections in split screen mode. The control device is connected to an actual state of motion signal line, so that depending on the actual state of motion of the vehicle, the display device displays at least two display signals originating from at least two different monitoring devices in split screen mode.

### BACKGROUND OF THE INVENTION

1) Field of the Invention

The present invention relates to a system for monitoring the surrounding area of vehicles, a motor vehicle equipped with such a system, as well as a method for operating such a system.

2) Description of Related Art

For monitoring the surrounding area of vehicles, especially commercial vehicles, at least two monitoring devices, for example proximity sensors or video cameras, are commonly used to monitor different sections in the surrounding areas around the vehicle and output signals, such as video information providing a display signal, to a control device connected to the monitoring devices. The control device is connected to a display device, which is located in the field of view of the driver of the vehicle and is capable of displaying the display signals from the monitoring devices.

Using switching operations that operate the control device, the driver is able to select how the display signal is displayed on the display device, whereby the display requirements may change depending on the actual state of the vehicle (e.g. state of motion).

For example, the driver needs a different display on the display device when his vehicle is in a “normal” state of motion (“normal” here means driving straight on a street without any unusual circumstances requiring specific attention) than he does when in reverse or routing etc. Likewise, a different type of display on the display device is necessary or preferred for stop-and-go driving within cities than that necessary or preferred for fast overland driving or freeway driving.

Therefore, by activating the corresponding switch the driver is able to select from the monitoring devices available to him the one that delivers the display signal to the display device he needs or prefers for the momentary state of motion of the vehicle.

By using the display signals from the monitoring devices, which change according to the switching operation, the driver can, in theory, maneuver his vehicle with greater safety and accuracy. Increased safety not only pertains to his vehicle but also to persons or objects that under certain circumstances may not be within direct view of the driver because they are in a blind spot.

There are guidelines and field of vision classifications, particularly for commercial vehicles, which specify the field of view characteristic of vehicles that must be made visible by the corresponding monitoring devices.

However, if the state of motion of the vehicle changes during operation, or if one and the same state of motion requires, for example, changing views of different fields of view, the driver must change the display signals on the display device by activating the corresponding switches (e.g. switching between different fields of view). An example might be that a driver must maneuver his vehicle in reverse up to a loading ramp after reaching his destination once he has driven into the city. Whether transitioning from a freeway or highway trip to city traffic or routing to the destination, the driver must select a display on the display device that gives him the exact display information he needs or is most useful for the respective situation, e.g. the state of motion or operation of his vehicle.

This disadvantageously means that the corresponding switching and/or adjusting operations must be carried out by the driver using the display device or its control device. In doing so, the driver unnecessarily becomes distracted because in one case he must take one hand off of the steering wheel in order to operate the monitor or control device and in the other case he must continually glance at the display device in order to visually check whether the optimal setting or display has been achieved on the display device for the respective state of motion.

This represents a great burden and a high degree of distraction for the driver. In a worst-case scenarios, the driver refrains from taking a hand from the steering wheel to implement the most optimal or useful setting on the display device due to the high degree of distraction and impracticality or hazardous situations/accidents occur as a result of the quick distraction.

Accordingly, it is an object of the present invention to provide a system for monitoring the area surrounding a vehicle, particularly for large commercial vehicles, so that a display on the display device is possible that is best suited for the respective state of motion without the driver having to manually operate display controls to achieve an optimum display for a given vehicle state.

### SUMMARY OF THE INVENTION

The above objective is accomplished according to the present invention by a control device connected to an actual state signal line and depending on the actual state of the vehicle, displays at least one display signal originating from at least two different monitoring devices on the display device without requiring any action by the driver. Accordingly, the driver is therefore relieved of the task of having to manually implement switching procedures to display on the display device the display signals from among multiple monitoring devices, because depending on the actual state of the vehicle this is automatically prompted by the control device, which signals to the control device a multitude of actual states of the vehicle.

In one embodiment, at least two display signals originating from at least two different monitoring devices are displayed in a split screen mode on the display device depending on the actual state of the vehicle. Operating versatility, and above all safety, are enhanced as a result because the driver has at least two displays available to him simultaneously, whereby the displays can change, i.e. switch individually or jointly according to the actual state of the vehicle. The preferred definition of the actual state of a vehicle is the state of motion and/or configuration of the vehicle. “State of motion” here means the movement of the vehicle, especially direction and speed. “Configuration” means, e.g. the arrangement of the vehicle according to length (with or without trailers), design, cargo etc.

For this purpose, it is preferred that at least two of the following states of vehicle motion are displayable over the actual state signal line, namely “Forward travel—straight ahead”, “Forward travel—turning left”, “Forward travel—turning right”, “Reverse travel” and “Standstill”. These are states of vehicle motion/driving conditions typical of normal operation and represent the primary demands of image display that arise in the field. They are selected on the display device—with an optional split screen mode—using the control device based on the current states of motion.

The monitoring devices may constitute cameras according to a preferred embodiment of the invention, which detect different close-up ranges around the vehicle. The signals output by the respective cameras are then—optionally after corresponding processing or revision by the control device—output to the display device and displayed there as real-time images. The sensitivity range in which one or more of the cameras functions can be adjusted or selected as required. It is possible, for example, to operate one or more of the cameras in the infrared area and not in the visible wavelength range.

In one embodiment, the invention provides for two monitoring devices in the form of video cameras, the first camera can be a front camera that monitors the blind spot directly in front of the vehicle (field of view classification VI).

In a further embodiment, the invention provides for two cameras, the first camera detecting the field of view of a wide angle mirror and the second camera detecting the field of view of a primary mirror. Coverage of field of vision classifications II through IV can be achieved with a such combination. Furthermore, a third monitoring device with or in the form of a third camera can be provided, whereby this third camera detects the field of view of a roof mirror, which meets field of view classification V.

According to an additional embodiment of the invention, a fourth monitoring device with or in the form of a fourth camera can be provided, whereby this fourth camera detects the field of view behind the vehicle.

Furthermore, a fifth monitoring device can be provided, which has at least one, preferably multiple sensors for detecting objects and/or obstacles in the lateral close-up range or area around the vehicle and/or sensors for detecting vehicle configuration. This fifth monitoring device can detect distances to objects and/or obstacles, e.g., by radar, ultrasound etc.

Accordingly, the control device can preferably display warning signals from the fifth monitoring device on the display in addition or alternatively to the display of output signals from the first through third monitoring devices (first through fourth camera), for example, in the form of warning symbols or warning messages inserted into the image signal(s).

According to an embodiment of the method of the present invention, when in the actual state “Forward travel—straight ahead”, the field of view in front of the vehicle and the field of view from a primary mirror are simultaneously displayed on the display.

It is preferable that the field of view of the primary mirror is displayed larger than the field of view in front of the vehicle.

Furthermore, it is preferable in the method of the present invention that the area directly in front of the vehicle and the area to the left of the vehicle are simultaneously displayed on the display when in the actual state “Forward travel—turning left”. Likewise, the area directly in front of the vehicle and the area to the right of the vehicle are simultaneously displayed on the display when in the actual state “Forward travel—turning right”.

Furthermore, in the method of the present invention, the areas directly in front of and to the left and/or right of the vehicle are simultaneously displayed on the display when in the actual state “Standstill”.

Furthermore, according to the present invention, the areas directly behind and to the left and/or right of the vehicle are simultaneously displayed on the display when in the actual state “Reverse travel”.

It is preferable that the area behind the vehicle is displayed larger than the areas to the left or right of the vehicle.

In a further embodiment, each of the display possibilities described above can also be executed in split screen mode.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a schematically simplified view of a display device screen surface, without any special displays in the individual split screen areas according to the present invention;

FIG. 2 shows a schematically simplified structural design of the monitoring device of the present invention; and

FIGS. 3-5 each correspond to the displays in FIG. 1 but show different display formats or display images in the respective split screen areas.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail.

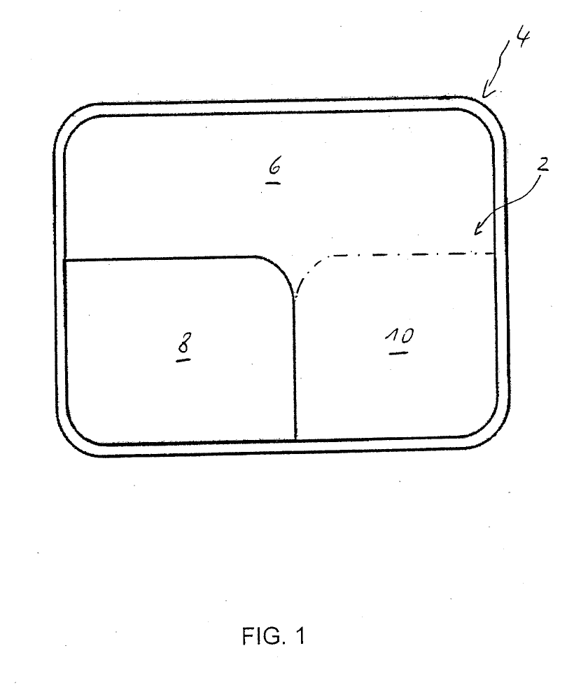

Referring to FIG. 1, a screen surface 2 of a display device 4 is shown. The display device 4 is arranged in the driver's line of sight in the cabin/passenger compartment in such a way that he has a comfortable view of the screen surface 2 and the displays shown there.

According to FIG. 1, the screen surface 2 is divided into two different sections 6 and 8, whereby the display of sections 6 and 8 is preferably executed in a so-called split screen mode, i.e. the screen contents displayed in sections 6 and 8 are adjacent and independent.

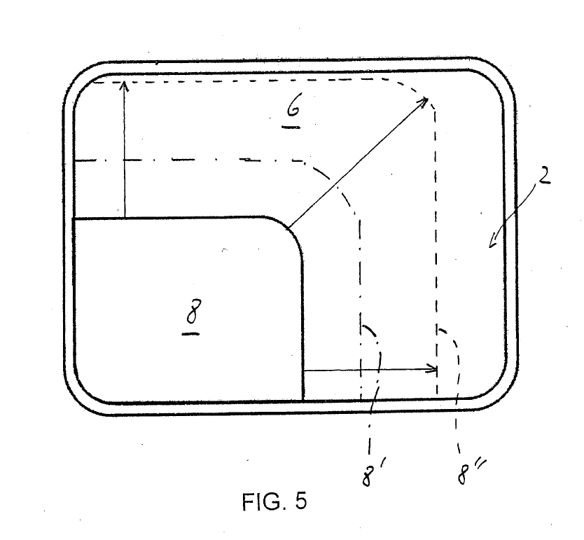

In the embodiment shown in FIG. 1, the display section 8 takes up approximately one quarter of the entire screen surface 2 and is located in the lower left quadrant of screen surface 2. Such an arrangement of the section 8 is merely an example. Just as well, the section 8 could be located in the upper left, upper right or lower right quadrant of the screen surface 2. Furthermore, the size of the section 8 is not limited to the size shown in FIG. 1 as explained below in reference to FIG. 5.

Furthermore, it is possible to divide the screen surface 2 into more than just two sections (sections 6 and 8) as shown by the dot-dash line in FIG. 1, where to the right of section 8 an additional section 10 is indicated, thus providing a three-way split screen.

It must be specifically established, however, that the split screen-suitable design of the screen surface 2 displays a preferable embodiment of the invention. The basic idea of the present invention is likewise feasible for a screen surface 2 that is only capable of displaying a single image, whereby the user must switch between individual image displays. For screens of this type, the object of the present invention represents considerable relief for drivers by eliminating the need for the driver to manually select the image to be displayed on the screen.

The following description, however, is based on a screen surface 2 that is suitably designed for a split screen display as represented in the Figures.

Additional mini-displays or symbols can be inserted into section 6 and/or 8 and/or 10 as shown below.

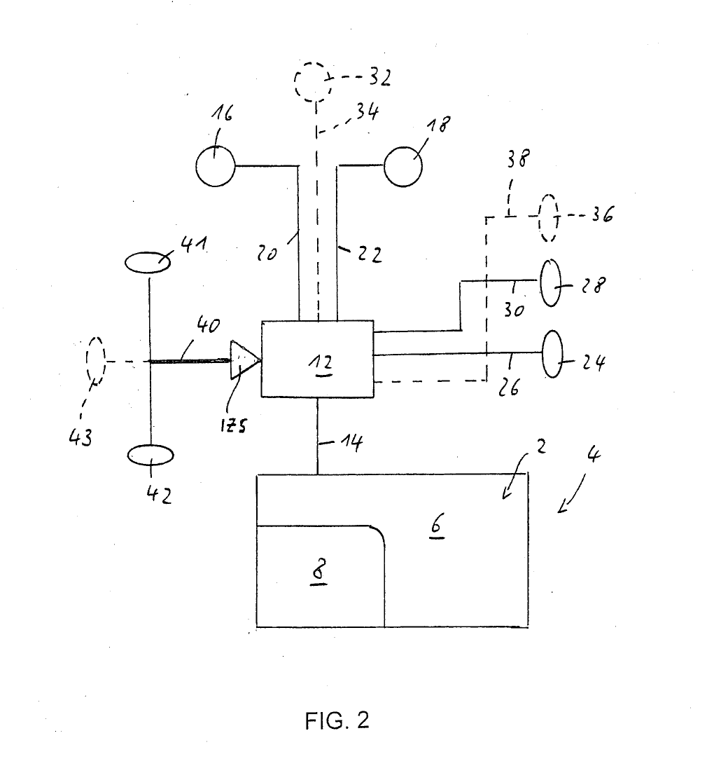

FIG. 2 schematically shows the design of the monitoring device according to the invention with which the area surrounding a vehicle can be observed or monitored. The device basically consists of the display device 4 as described above in reference to FIG. 1, with the screen surface 2 and a control device 12, which is connected to the display device 4 over a signal line 14. The control device 12 receives display signals from at least a first and a second monitoring device 16 and 18 via the corresponding signal lines 20 and 22. Furthermore, the control device 12 may receives signals from at least one additional monitoring device 24 over a signal line 26. In this case, the monitoring device 24 is constructed differently in terms of design and function than monitoring devices 16 and 18 to provide a variety of monitoring information to control device 12. Furthermore, an additional monitoring device 28 may be present with a corresponding signal line 30 in addition to monitoring device 24. The monitoring device 28 may be identical to monitoring device 24 or different in regard to design and function than monitoring device 24 as well as monitoring devices 16 and 18.

In FIG. 2 a dashed line indicates that in addition to monitoring devices 16 and 18, an additional, or more if necessary, monitoring device 32 may be present, which is/are connected via multiple signal lines 34 to the control device 12. Analogous to this, an additional monitoring device 36, or more, may be present with one or more associated signal line(s) 38, which is/are allocated to monitoring device(s) 24 and/or 28.

The control device 12 receives the output signals from monitoring devices 16, 18 and 24, whereby for clarity reasons for the displays, subsequent restrictions on these monitoring devices 16, 18 and 24 should occur.

In one embodiment of the invention, the monitoring devices 16 and 18 are cameras, for example CCD video cameras, which deliver image signals over the lines 20 and 22 to the control device 12. The image signals processing may take place in the area of the cameras 16 and 18 so that the control device 12 receives fully processed image signals. Alternatively, it is possible to convert the video signals delivered by cameras 16 and 18 into the corresponding image signals from the very start in the area of the control device 12. The control device 12 outputs the fully processed image signals to the display device 4 via the signal line 14 where the image signals are then displayed accordingly in sections 6 and 8 in split screen mode.

In a preferred embodiment, the monitoring device 24 is different with regard to function and effect than the monitoring devices 16 and 18, which are designed as cameras. For example, monitoring device 24 may be a sensor with which objects and/or obstacles in the close-up range of the vehicle can be detected. Sensors of this type use ultrasound, light, radar and various other techniques well known to those skilled in the art. Output signals from sensor 24 reach the control device 12 via signal line 26 where they are processed (analyzed, evaluated, compared with threshold values etc.) and output via the signal line 14 to the display device 4 to provide a desired indication for a given condition.

In one embodiment, physical values detected by the sensor 24 can then be displayed in the area of section 6 and/or in the area of section 8 in the form of symbols, numerals, letters etc., for example, in the form of fading or cross fading technology.

The cameras 16, 18, 32 work exclusively in a sensitivity range, for example, exclusively in a visible wavelength range. Alternatively, at least one of these cameras also works in an invisible wavelength range, for example, in the infrared area. Likewise, the monitoring devices 24, 28, 36, which are designed as sensors, are not functionally limited to one type of sensor, but can also detect different physical values, if applicable, and can detect one and the same physical value with different sensitivities etc.

The control device 12 receives an actual state signal (ASS) over an actual state signal line (ASSL) 40, which displays the actual state (driving condition and/or configuration) of the vehicle in which the monitoring device according to the invention is installed. The actual state signal is a signal, or is generated from multiple signals, that comes from at least one actual state sensor 41, 42, 43. Examples for the actual state sensor(s) 41, 42 and 43 are: a speed sensor that measures the current speed of the vehicle; a transmission sensor that detects the switching state of the vehicle transmission; a steering sensor that detects the steering angles of the steering wheel according to direction, value and end position etc.; sensors for detecting whether the vehicle is pulling a trailer that change the vehicle length accordingly; sensors for the vehicle length; sensors for load dimensions or weight etc., and virtually any other aspect or arrangement on the vehicle that can be monitored. The actual state signal is appropriately generated from one or more output signal(s) from the actual state sensors 41, 42, 43 and entered into the control device 12 over the actual state signal line 40.

The control device 12 detects the momentary state of motion or driving condition of the vehicle and/or the vehicle configuration using the actual state signal (ASS), which it uses for the display on the display device 4.

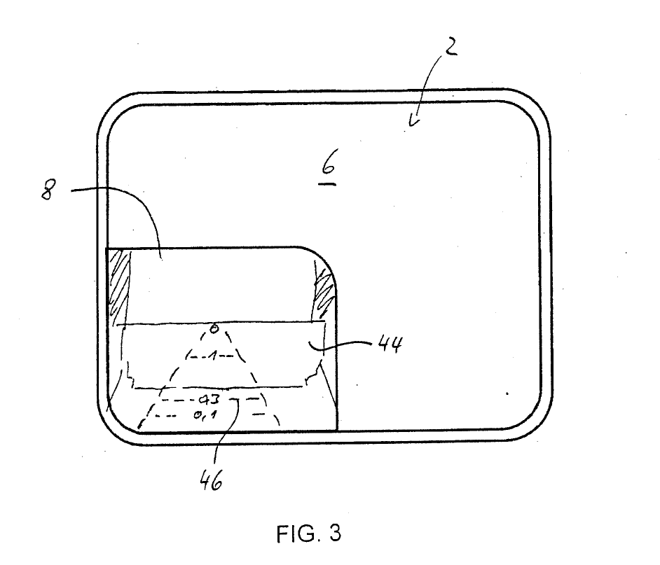

FIG. 3 shows a display example on the screen surface 2 where the field of view of a rear camera is inserted in section 8 in order to make maneuvering up to a ramp 44 easier, whereby additional auxiliary displays can even be inserted, for example a distance indicator 46. The surface of section 6 shows another area surrounding the vehicle, for example, the view of a lateral roof mirror, front mirror or front camera, i.e. according to field of view classification(s) V and/or VI.

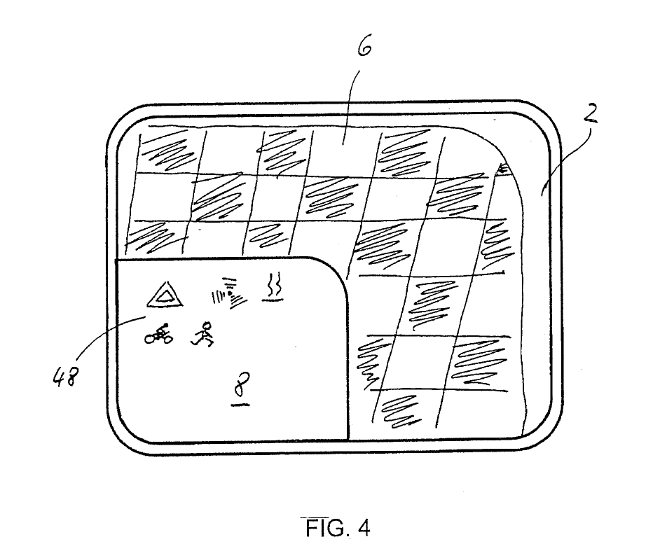

FIG. 4 shows a display that presents symbols 48 in section 8 that alert the driver to certain situations, hazards etc. The symbols 48 are exclusively limited to section 8 in the display example in FIG. 4. Alternatively, they can also be completely or partially displayed in section 6 or, if applicable, in additional sections (for example, section 10 in FIG. 1).

The main image contents in sections 6 and 8 (whereby that in FIG. 6 is schematically simplified as a model and is not included in a closer display in section 8) are based once again on the respective states of motion and/or configurations of the vehicle.

FIG. 5 shows the options for defining variable values in sections 6 and 8; for example, the infinitely variable or gradual expansion of the value of section 8 depending on speed—if applicable, when exceeding or falling below a certain threshold speed, for example 30 km/h as shown in FIG. 5 with the dot-dash line (reference symbol 8′) and dotted line (reference symbol 8″). In doing so, the display in section 8, for example, can be given increased priority relative to section 6 in the case of increasing or decreasing speed. If a small border area around section 6 still remains after completely expanding section 8 as shown in FIG. 5, it can be used for displaying warning signals or other symbols. Another option is to expand section 8 until section 6 is completely covered. This is based on the respective requirements of the individual states of motion of the vehicle. When in slow forward travel for example, the image from the front camera, which in this situation is especially important, can take up the entire or a considerable portion of the screen surface 2.

In one embodiment of the present invention, control device 12 is able to detect the respective actual state of the vehicle from the actual state signal and independently display the signals from monitoring devices 16, 18, 32, 24, 28, 36 (to keep with the terminology of the embodiment of the invention from FIG. 2) in a suitable manner on the screen surface 2. The display is executed either according to a preset display scheme or the driver of the vehicle is able to set the display scheme in advance in order to meet personal preferences or constantly recurring driving situations.

The first and second monitoring devices 16 and 18 are preferably cameras, which for example, detect different close-up ranges around the vehicle. In doing so, the first camera 16 and the second camera 18 detect and display the field of view of a wide angle mirror and the field of view of a primary mirror respectively. A primary mirror view is generally defined by a large flat mirror surface with a generally rearward view with a defined amount of surface area to meet required laws. The third camera 32 detects and displays, for example, the field of view of a lateral roof mirror. An additional camera not shown in FIG. 2 can detect the field of view behind the vehicle (for example, section 8 in FIG. 3). Sensors 24, 28 and 36 according to FIG. 2 are, for example, distance measuring sensors, proximity sensors, movement sensors, temperature sensors etc. and serve in particular to generate the symbols 48 according to FIG. 4, which are insertable in section 8 and/or 6 (or, if applicable, in additional sections if the screen surface is split into more than two areas).

The control device 12 uses the actual state signal (ASS) coming from the actual state sensors 41, 42, 43, to detect the current state of motion or driving condition of the vehicle and/or uses this as the basis for the vehicle configuration displayed on screen surface 2, for example, the type and/or quantity of partitions for the split screen display and the type of display in the individual sections of the screen surface, i.e. which image signal is to be displayed by which camera and/or which symbol(s) 48 is/are to be displayed on which screen surface section and, if applicable, the division or size of the individual sections (see FIGS. 1 and 5). Furthermore, certain image signals can be given priority in the case of certain states of motion and/or configurations.

For example, when in actual state “Forward travel—straight ahead”, the field of view in front of the vehicle and the field of view from a primary mirror can be simultaneously displayed on the display device 4. When the vehicle speed increases, the field of view in front of the vehicle becomes of less importance and according to FIG. 5, section 8 expands, which displays the field of view of the primary mirror while section 6 is displaced into the background, which displays the field of view in front of the vehicle.

When in actual state “Forward travel—turning left” or “Forward travel—turning right”, the area directly in front of the vehicle and the areas to the right and left of the vehicle can be displayed simultaneously on the screen surface 2. The partition of displays “Area in front of the vehicle” and “Areas to the left and right of the vehicle” in screen surface sections 6 and 8 is either preset or can be individually set by the driver in advance.

Furthermore, the area directly in front and to the left and/or right of the vehicle are simultaneously displayed on the monitor when in the actual state “Standstill”. If the area directly in front of the vehicle and the areas to the right and left of the vehicle are displayed simultaneously on the screen surface 2, then a division of the screen surface 2 into sections 6, 8 and 10 would be conceivable as in FIG. 1.

The individual states of motion or driving conditions depicted above are merely examples. It is possible within the scope of the present invention to detect and convert additional states of motion of a vehicle into the corresponding screen displays. The driver of the vehicle can also be given the option of programming individual states of motion of the vehicle into the control device, so that the control device provides displays that are customized to the driver and his area of responsibility. The driver can carry with him, for example in the form of a portable storage device (CD-ROM, USB stick etc.), individual settings like those described and set or program the control device 12 accordingly.

Furthermore, the driver can also be given the option to manually recall at any time any settings or programming of the control device that already exist, whether temporarily or permanently.

The present invention releases the driver in day-to-day operations from undertaking switching procedures to change the display settings on the display device 4 best suited for the respective vehicle operation or the respective actual state of the vehicle, because said settings are executed automatically by the control device 12 by analyzing the actual state signal. As a result, the driver can pay much more attention to steering his vehicle and isn't distracted by switching procedures in especially critical situations that require two hands on the steering wheel.

While a preferred embodiment of the invention has been described using specific terms, such description is for illustrative purposes only, and it is to be understood that changes and variations may be made without departing from the spirit or scope of the following claims.

What is claimed is:

1. An automated monitoring system for monitoring the area surrounding a vehicle comprising:
at least a first monitoring device and a second monitoring device each monitoring a different portion of the area surrounding the vehicle and outputting display signals;
a control device connected to said first and second monitoring devices;
a display device that is connected to the control device for displaying the display signals from said first and second monitoring devices; and, wherein said control device is connected to an actual state signal line for receiving signal information from at least one actual state sensor as to the actual state of the vehicle so that depending on the actual state of the vehicle said control device selectively displays at least one display signal selected from at least said first monitoring device and said second monitoring device on the display device.

2. The system of claim 1 wherein said control device depending on the actual state of the vehicle, displays at least two display signals originating from at least said first monitoring device and said second monitoring device in a split screen mode on the display device.

3. The system of claim 2 wherein said actual state of the vehicle is defined by a state of motion of the vehicle and/or a configuration of the vehicle.

4. The system of claim 3 wherein said state of motion of the vehicle transmitted over the actual state signal line is selected from the group consisting of “Forward travel—straight ahead”, “Forward travel—turning left”, “Forward travel—turning right”, “Reverse travel” and “Standstill”.

5. The system of claim 4 wherein said first and second monitoring devices detect different fields of view around the vehicle.

6. The system of claim 5 wherein said first monitoring device is a first camera positioned to monitor a field of view in front of the vehicle, and wherein said second monitoring device is a second camera positioned on one of a side or rear of the vehicle to view a different area around the vehicle from said first camera.

7. The system of claim 6 wherein said first camera 16 detects and displays a wide angle mirror field of view in said display device, and said second camera 18 detects and displays a primary mirror field of view.

8. The system of claim 7 including a third monitoring device provisioned with a third camera that detects a field of view of a roof mirror.

9. The system of claim 8 including a fourth monitoring device provisioned with a fourth camera that detects a field of view behind the vehicle.

10. The system of claim 9 including a fifth monitoring device that includes sensors for detecting objects and obstacles within a defined range lateral to the vehicle.

11. The system of claim 10 wherein said fifth monitoring device detecting distances to objects and obstacles.

12. The system of claim 11 wherein warning signals resulting from said fifth monitoring device are displayable on said display device using said control device in addition to said display signals represented on said display device.

13. A method for operating an automated monitoring system of claim 12 including simultaneously displaying on said display device said field of view in front of the vehicle and said primary mirror field of view when in said actual state “Forward travel—straight ahead”.

14. The method of claim 13 including displaying said primary mirror field of view larger than said field of view in front of the vehicle in said display device.

15. The method of claim 14 including automatically changing the display on said display device to simultaneously display on said display device said field of view in front of the vehicle and a field of view to the left of the vehicle when said control device receives signal information from said at least one actual state sensor that the vehicle is in said actual state “Forward travel—turning left”.

16. The method of claim 14 including automatically changing the display on said display device to simultaneously display on said display device said field of view in front of the vehicle and a field of view to the right of the vehicle when said control device receives signal information from said at least one actual state sensor that the vehicle is in said actual state “Forward travel—turning right”.

17. The method of claim 14 including automatically changing the display on said display device to simultaneously display on said display device said field of view in front of the vehicle and a field of view to the left, right or behind of the vehicle when said control device receives signal information from said at least one actual state sensor that the vehicle is in said actual state “Standstill”.

18. The method of claim 14 including automatically changing the display on said display device to simultaneously display on said display device a field of view directly behind the vehicle and a field of view to the left or right of the vehicle when said control device receives signal information from said at least one actual state sensor that the vehicle is in said actual state “Reverse travel”.

19. The method of claim 18 including displaying said field of view behind the vehicle larger than said field of view to the left or right of the vehicle in said display device.
